(19) United States
(12) Patent Application Publication
(10) Pub. No.: US 2026/0101158 A1
(43) Pub. Date: Apr. 9, 2026

(54) METHODS AND SYSTEMS FOR COMMUNICATION MANAGEMENT

(71) Applicant: Comcast Cable Communications, LLC, Philadelphia, PA (US)

(72) Inventors: Vengatarajulu Rajasekar, Mount Laurel, NJ (US); John DePietro, Mount Laurel, NJ (US); Eric Wong, Mount Laurel, NJ (US)

(21) Appl. No.: 18/909,587

(22) Filed: Oct. 8, 2024

(51) Int. Cl. H04W 4/14

(52) U.S. Cl. CPC H04W 4/14

(57) ABSTRACT

Methods and systems for communication handling and management are described. Supplemental data may be inserted into an outgoing call. It may be determined the recipient device or associated network is not configured to process the supplemental data. The supplemental data may be converted to an alternate message for delivery and output at the recipient device.

### BACKGROUND

There is a need for additional information to be provided with telephone calls, and rich call data (RCD) protocols have been created to provide more information about a calling party. One reason for needing such information is a rise in spam calls. Another reason is for legitimate calls from unknown numbers to provide additional information. While RCD offers significant benefits in terms of call context and user experience, its adoption faces challenges due to the diverse ecosystem of communication devices and networks. Many existing phones and network infrastructure components are not equipped to process or display RCD, or similar data. Additional challenges include other barriers to widespread adoption, and concerns about how to traverse multiple networks with varying capabilities. This disclosure addresses shortcomings in delivering information with telephone calls.

### SUMMARY

It is to be understood that both the following general description and the following detailed description are exemplary and explanatory only and are not restrictive. Methods and systems for call management are described. It may be determined that a receiving user device is not configured to process RCD. For example, a computing device in a terminating network may receive (e.g., intercept) a call bound for a receiving user device. For example, the computing device may determine the receiving user device is not configured to process the RCD and the computing device may convert the RCD to short message service (SMS) data. If the receiving user device is not configured to process the RCD, the RCD may decoded and reconfigured as one or more messages (e.g., text messages, emails, social media notifications, etc...) and sent to the user device. For example, the computing device may parse one or more RCD claims and format an SMS message based on the parsed RCD claims. After constructing an SMS message based on the RCD, the SMS message may be sent to the receiving user device.

### BRIEF DESCRIPTION OF THE DRAWINGS

The accompanying drawings, which are incorporated in and constitute a part of this specification, show examples and together with the description, serve to explain the principles:

FIGS. 1A-1B show an example system;

FIG. 2 shows an example system and method;

FIG. 3 shows an example system and method;

FIG. 4 shows an example system and method;

FIG. 5 shows example data and processing;

FIG. 6 shows an example system and method;

FIG. 7 shows an example method;

FIG. 8 shows an example system and method;

FIG. 9 shows an example method;

FIG. 10 shows an example method;

FIG. 11 shows an example method;

FIG. 12 shows an example method; and

FIG. 13 shows an example system for communication management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as”is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information. ” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (. EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

The present methods and systems provide an improvement in communications technologies and related technologies.

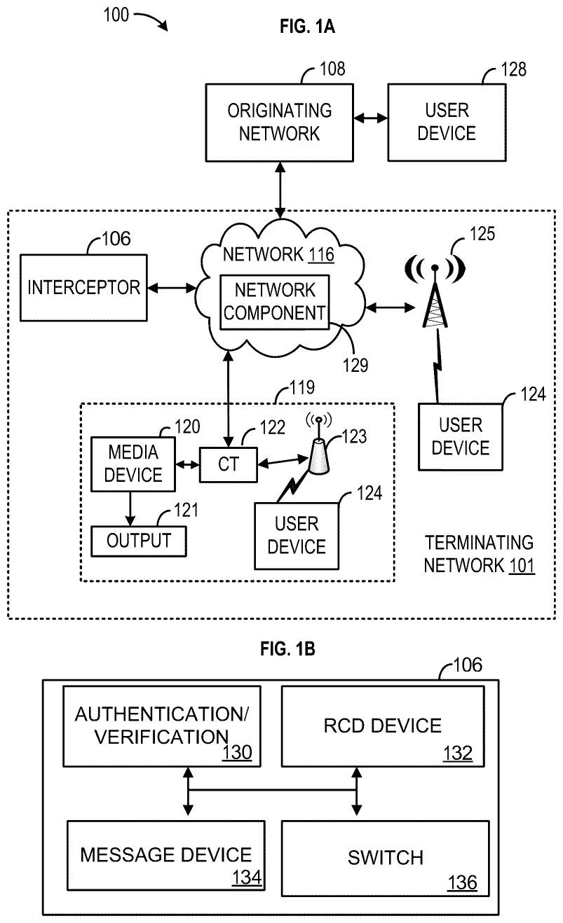

FIG. 1 shows a system 100 for communication management. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a terminating network 101, an originating network 108, and one or more intermediary networks. Although network 116 is shown in the terminating network 101, the illustration is merely exemplary and explanatory and not limiting. For example, the network 116 may be an intermediary network (e.g., a transit network) between the terminating network 101 and the originating network 108. The system 100 may comprise a terminating user device 124 in the terminating network and an originating user device 128 associated with the originating network 108. The terminating network 101 may comprise an interceptor device 106, a media device 120, an output device 121, a communications terminal 122, a first access point 123, a second access point 125 (e.g., a headend, fiber optic, or satellite communications facility), various other devices, combinations thereof, and the like.

The network 116 may facilitate sending data to and from the various devices of the system 100. The network 116 may be a telecommunications network, a content delivery network, a content access network, combinations thereof, and the like. The network may be managed (e.g., deployed, serviced) by a content provider, a service provider, combinations thereof, and the like. The network 116 may be a plain-old telephony (POTS) network, a wireless cellular network, an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The user device 124 may comprise one or more of a cell phone, a smart phone, a laptop computer, a desktop computer, a tablet, a virtual assistant device, a plain old telephone (POTS), combinations thereof and the like.

The user device 124 may be configured to receive an incoming call and/or to place an outgoing call. The term “incoming call” refers to a point of view of the device and/or network receiving the call (e.g., the terminating device or the terminating network). The term “outgoing call” may refer to the same call, but from the point of view of the device placing the call and/or the network associated with the device placing the call. For example, a call may be placed by the user device 128 (e.g., the originating device) and directed towards the user device 124 (e.g., the terminating device). Thus, from the point of view of the user device 128, the call is an outgoing call, but from the point of view of the user device 124, the call is an incoming call.

The call may be sent by a user device (e.g., a user associated with the user device may dial a number). The outgoing call may be sent via one or more first protocols. For example, the one or more first protocols may comprise one or more of: Plain Old Telephony Service (POTS), WebRTC, HTTP/HTTPS, email or other messaging service, push notifications, one or more data fetches, and/or an SIP protocol message. For example, the call may be placed automatically in response to a wake word or other similar trigger. The call may be bound for a recipient device (e.g., the user device 124). The recipient device may be associated with the recipient network (e.g., the terminating network 101). The call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The call may comprise supplemental data. The supplemental data may comprise rich call data (RCD). The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. For example, the rich call data may comprise caller identifier information such as a name, contact information, phone numbers, addresses, combinations thereof, and the like. For example, the rich call data may comprise the responses to the one or more outputs (e.g., the user inputs received in response to the one or more prompts) so as to convey additional information to the recipient of the call. The rich call data may comprise image data (e.g., a logo), text data (e.g., a message configured to be displayed via the recipient device), audio data, one or more resource identifiers (e.g., one or more URLs, or the like), combinations thereof, and the like.

The supplemental data may comprise caller ID data, call parameter data, session description data, media negotiation data, network address data, call routing data, presence data, service-specific data, and/or error and status data. For example, in a VoIP invite or call initiation message, various supplemental data elements may be included to manage and facilitate the communication session. For example, the caller ID data may comprise essential information about the caller, such as their name, phone number, or username. For example, the call parameters may be conveyed to specify settings like call type (voice, video, conference), priority, supported codecs, and preferred media formats. For example, the session description may be provided, delineating session characteristics such as duration, start and end times, and any associated scheduling details. For example, media negotiation information is exchanged to determine compatible codecs, media formats, and bandwidth constraints between parties. For example, the network addressing information, including IP addresses and ports, may be shared to establish the connection between the calling and called parties. For example, the authentication and security details, encompassing mechanisms, encryption algorithms, and protocols used to secure the session, may be communicated. For example, the call routing information is may be communicated to indicate the path and network elements involved in connecting the parties, including gateways or proxies. For example, the presence information may convey the availability status of the caller, indicating whether they are reachable at the moment. Additionally, service-specific data such as call history, recording preferences, or customized features may be included. Further, error and status codes may be transmitted to communicate the outcome of the call initiation process, indicating success, failure, or encountered errors.

The interceptor device 106 may detect the incoming call. The interceptor device 106 may comprise one or more of a switch 136, and RCD device 132, an authentication/verification device 130, a message device 134, combinations thereof, and the like (as shown in FIG. 1B). The switch may comprise various components within a cellular network infrastructure, facilitating the routing of calls, data, and other communication signals between different network components. For example, among these components may be the Mobile Switching Center (MSC), responsible for managing call setup, routing, termination, and mobility management between mobile devices and external networks such as the Public Switched Telephone Network (PSTN). The switch may comprise a Base Station Controller (BSC) configured to oversee multiple Base Transceiver Stations (BTS) and manage radio resources and handovers. In modern networks like 4G LTE and 5G, packet switches are essential for handling data traffic, ensuring the smooth transmission of data packets between various network elements. These switches collectively manage voice and data traffic, optimize network resources, and uphold reliable connectivity for users across the cellular network.

The interceptor device 106 may determine the call comprises supplemental data (e.g., rich call data). For example, the interceptor device 106 may comprise an authentication/verification device 130. Alternatively, the authentication/verification device 130 (e.g., a STIR/SHAKEN server) may be a separate device. The authentication/verification device 130 may be configured to implement the Secure Telephone Identity Revisited (STIR) and Signature-based Handling of Asserted Information Using toKENs (SHAKEN) framework, which authenticate and verify caller identities. This process involves digitally signing caller information and transmitting it across the network to ensure its integrity and authenticity. For example, when a call is initiated, an originating service provider (e.g., OSP associated with the originating user device 128 and/or originating network 108) receives a call setup request and uses a STIR/SHAKEN authentication service to generate a digital certificate. The digital certificate contains information about the calling party's number and the OSP's identity, which is then signed using a private key to create a digital signature.

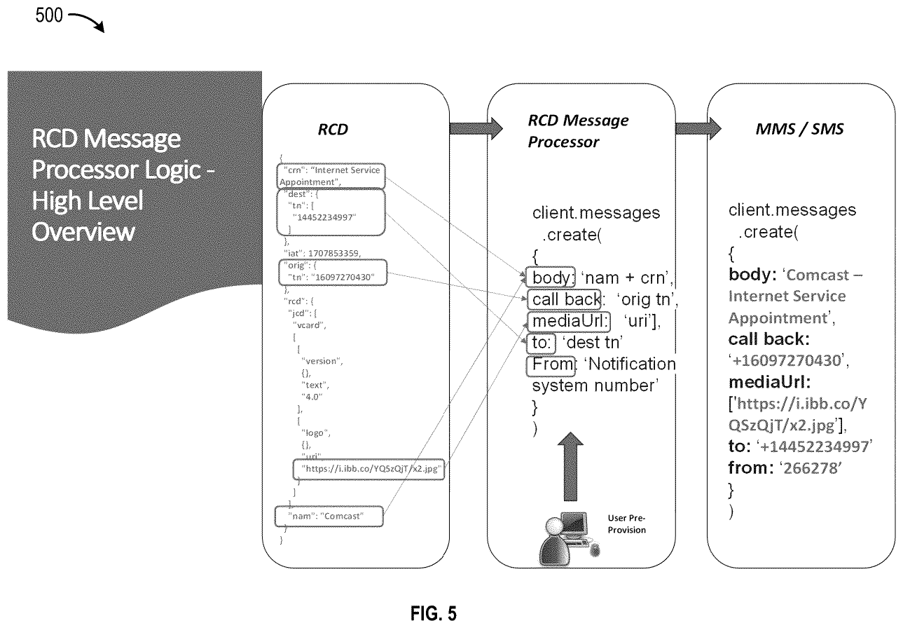

The authentication/verification device 130 may determine if the incoming call contains RCD. For example, an identity header may comprise RCD (e.g., one or more RCD claims, as described in greater detail with respect to FIG. 5). For example, the authentication/verification device 130 may decode the identity header, which may contain RCD. If so, the authentication/verification device 130 may determine to send the call and the RCD to the RCD device. For example, the authentication/verification device 130 may send the RCD to the RCD device to be repackaged into an alternate message (e.g., a text message (SMS/MMS), an email, a social media message/alert/notification, combinations thereof, and the like.

The interceptor device 106 (e.g., via the RCD device 132) may determine a user device identifier associated with the recipient device (e.g., an identifier associated with the user device 124). For example, the RCD device 132 may determine, for example, based on the user device identifier associated with the recipient device, that the recipient device is not configured to process the supplemental data. For example, the RCD device 132 may comprise an internal look-up table. The internal look-up table may comprise one or more device identifiers and one or more device attributes associated with one or more recipient devices associated with the terminating network. For example, the internal look-up table may comprise (e.g., may indicate) one or more display attributes associated with the one or more recipient device associated with the terminating network. The internal look-up table, and display attributes stored therein, facilitate the repackaging of the RCD to another protocol (e.g., an SIP invite) configured to be output on the recipient device that is not configured to process the RCD.

The determination as to whether or not any given recipient device is configured to process RCD may be based on a device identifier associated with the recipient device, a device model indicator associated with the recipient device, one or more display attributes associate with the recipient device (e.g., a number of characters which the recipient device display can output, including with or without scrolling characters, and/or a year of manufacture associated with the recipient device). For example, the display attribute associated with the recipient device indicates limited display capabilities, the RCD device 132 may repackage the RCD. For example, if the year of manufacture is earlier than a predetermined year, the RCD device 132 may determine the recipient device is not configured to process the RCD.

Based on determining the recipient device is not configured to process the RCD, the interceptor device 106 may take one or more actions. For example, based on determining the recipient device is not configured to process the supplemental data, the interceptor device 106 may cause the supplemental data (e.g., RCD) to be repackaged. For example, the interceptor device 106 may cause the supplemental device data be repackaged into an alternate message (e.g., a text message such an SMS/MMS message, an email, a social media message, combinations thereof, and the like). Thereby, the information included in the RCD packets, despite the absence of RCS capabilities on the recipient device, can still be output on the recipient device by virtue of having been repackaged to a different protocol (e.g., an SIP protocol).

The interceptor device 106 may decode the STIR/SHAKEN data to determine the supplemental data. The supplemental data may comprise one or more claims (e.g., support callback, name, company). The interceptor device 106 may determine one or more RCD headers, and thereby determine the presence of RCD.

For example, the interceptor device 106, based on determining the recipient device is not configured to process rich call data, may cause the recipient device to output text data.

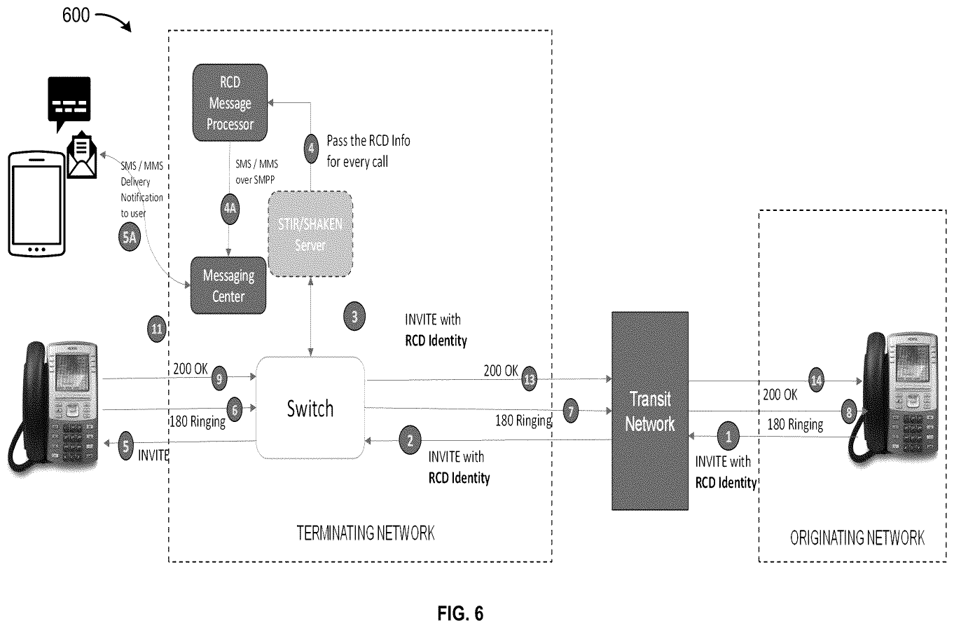

The text data may be output based on the one or more display attributes associated with the recipient device. For example, the RCD device 132 may determine display capabilities associated with the recipient device as described below with respect to FIG. 1B. The text data output may comprise the one or more RCD claims in the call initiation message that have been repackaged. For example, as described below with respect to FIG. 5 and FIG. 6, the one or more RCD claims (e.g., caller identity, reason for call) may be repackaged into a protocol compatible with the recipient device as, for example, one or more display names.

The interceptor device 106 may determine one or more call types associated with the outgoing call. The one or more call types may comprise, for example, a legitimate call type and/or a spam call type. For example, the intercept device may determine the one or more call types based on one or more identifiers associated with the device placing the outgoing call, one or more identifiers associated with a user of the device placing the outgoing call, one or more numbers (e.g., phone numbers) associated with the device placing the outgoing call, one or more identifiers associated with the device receiving the outgoing call, one or more identifiers associated with a user of the device receiving the outgoing call, one or more numbers (e.g., phone numbers) associated with the device receiving the outgoing call, combinations thereof, or the like. For example, the interceptor device 106 may determine the outgoing call is from a user device associated with a number on an authorized list and may intercept the call to facilitate the collection of data to insert into the call as Rich Call Data. For example, the intercept device 106 may determine the outgoing call is a spam call type based on the one or more identifiers. Based on determining the outgoing call is a spam call, the interceptor device 106 may not intercept the spam call. Based on determining the outgoing call is a spam call, the interceptor device 106 may insert one or more preconfigure rich call data into the spam call (e.g., a notification the call may be spam).

Returning to the components of system 100, the media device 120 may be configured to receive content and other associated data (e.g., metadata). The media device 120 may comprise a user device such as an STB, computer, mobile phone, combinations thereof, and the like. The media device 120 may be a digital streaming device, a gaming device, a media storage device, a digital recording device, a computing device, a mobile computing device (e.g., a laptop, a smartphone, a tablet, etc.), combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VoIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

FIG. 1B shows an example diagram of one or more components of the interceptor device 106. The interceptor device 106 may comprise an authentication/verification device 130. The authentication/verification device 130 may be configured to decode one or more RCD identity headers, one or more display names, SIP invite information, or other information as described herein in a call initiation message (e.g., call invite) sent from the sending user device. For example, if the interceptor device 106 is in the terminating network, the authentication/verification device 130 may decode one or more identity headers and validate one or more signatures to determine a valid (passed/failed) or no-validation status. For example, based on the verification results, the authentication/verification device 130 modify the call initiation message with additional parameters. For example, the authentication/verification device 130 may insert verstat in the FROM field and one or more PAI (P-Asserted Identity) headers on the SIP invite and add a “[v]” to the CNAM (display name) in the FROM and PAI headers. For example, the decoded RCD data may be inserted into the display name (CNAM) based on the capability of the recipient device.

The interceptor device 106 may comprise an RCD device 132. The RCD device 132 may be configured to determine one or more display parameters associated with a receiving user device. For example, the RCD display processor 132 may be configured to determine a number of characters capable of being displayed by the receiving user device. For example, the RCD display processor 132 may be configured determine, based on one or more user device identifiers associated with the recipient user device, that the recipient user device is an older device capable of only displaying up to 15 characters. Similarly, the RCD display processor 132 may be configured to determine, for example, based on one or more user device identifiers associated with the recipient user device, that the recipient user device is a new device (e.g., an IP enabled telephone) and is capable of displaying 34 or 44 characters. For example, the display capabilities of the recipient user device may be retrieved from a subscriber database (not shown). The RCD display processor 132 may be configured to determine display data to be displayed at (e.g., output via) the recipient user device. For example, the RCD display processor may determine the display data based on the display capabilities of the recipient user device. For example, if the recipient user device is only capable of displaying 15 characters, the RCD display processor 132 may send 15 characters to the recipient user device. For example, if the recipient user device is capable of displaying 34-44 characters, the RCD display processor 132 may cause 34-44 characters to be sent to the recipient user device. Further, if the recipient user device is has a scroll capability (which may also be retrieved from/determined by the subscriber database), the RCD display processor may cause more characters than can be displayed by the recipient user device to be sent to the recipient user device, and may cause the recipient user device to scroll so as to display additional characters (e.g., beyond the 15 or 34-44 characters).

The interceptor device 106 may comprise a message device 134. The message device may be configured to process, decode, add, remove, edit, store, or otherwise process data. For example, the message device 134 may be configured to generate one or more alternate messages based on the RCD data.

The message device 134 may be configured to determine, generate, receive, send, or otherwise process or provide one or more supplemental features. The one or more supplemental features may comprise, for example, one or more images (e.g., one or more logos, one or more pictures, etc), one or more hyperlinks, one or more applications or applets, one or more gifs, one or more advertisements, one or more emojis, one or more short videos, combinations thereof and the like. The message device 134 may be configured to activate or output, on the recipient device, the one or more supplemental features. For example, based on the text generated from the user inputs and/or RCD, the supplemental feature module may determine a logo associated with the company in the response, and cause output of the logo of the company at the recipient device or if the recipient device is not configured to process the logo, may convert text to speech and output the audio associated with the speech.

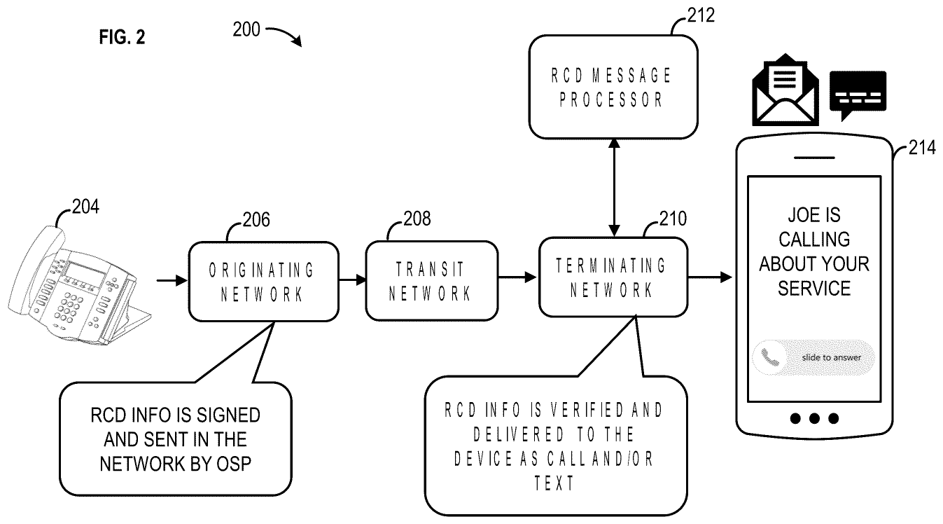

FIG. 2 shows an example method and system 200. The system 200 may comprise a terminating network 210, an originating user device 204 (e.g., the mobile device 128), an originating network 206, a transit network 208, a terminating network 210, an RCD message processor 212, and a recipient device 214. A call may be placed by user device 204. The call may be intended for user device 214. The call may traverse the originating network 206, (optionally) a transit network 208, and be received in the terminating network 210.

The outgoing call may be detected by a switch in the terminating network 210. The switch may be a device within a telephone exchange, such as the public switched telephone network (PSTN), configured to connect calls from the requester to the destination. The switch may be configured to detect a placed call, detect an “off-hook” condition associated with either or both of the user device 204 and/or the user device 214, detect and/or initiate a pre-call session (e.g., an early media session), similar conditions and/or one or more signals related thereto. The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The switch may route the call (e.g., to an interceptor as described herein). The interceptor may route the call to one or more other devices (e.g., as discussed in greater detail in herein). For example, the interceptor may route the call to an authentication/verification device (e.g., a STIR/SHAKEN server (not shown)), a call-log server (not shown), a pre-call announcement server (not shown), or any other device. A communication session may be established between the intercept device and either or both of the user device 204 and/or the user device 214. The communication session between the intercept device and the user device(s) may be established based on the intermediary device detecting the call.

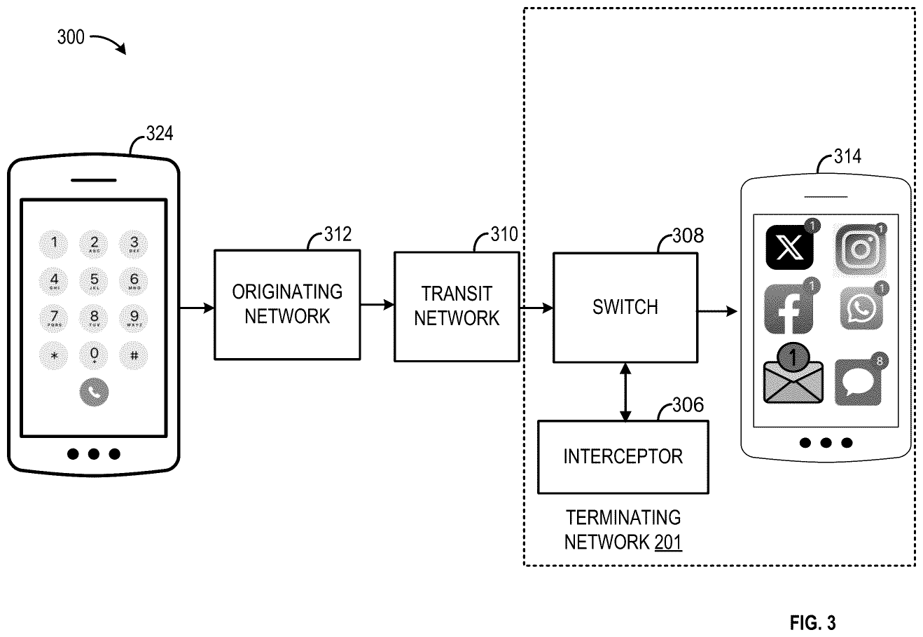

FIG. 3 shows an example system and method 300. Originating device 324 may send a call initiation message (e.g., a phone call, an invite). The call initiation message may comprise RCD. The call initiation message may be processed by an originating network 312 and sent to a transit network 310. The transit network 310 may send the call initiation message into a terminating network where it may be received by a switch device 308. The switch device 308 may route the call initiation message to an interceptor device 306 (e.g., the interceptor device 106 described in FIG. 1A and FIG. 1B). The interceptor device 306 may process the call initiation message and data associated therewith and cause one or more alternate messages to be sent to the recipient device 314. The one or more alternate messages may comprise one or more text messages (e.g., SMS/MMS), one or more emails, one or more social media messages/alerts/notifications, combinations thereof, and the like.

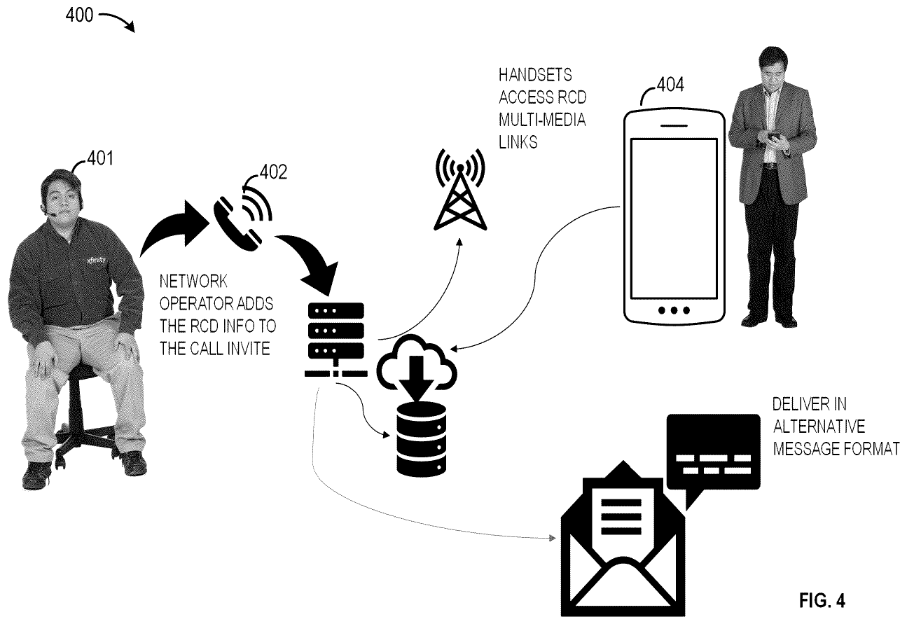

FIG. 4 shows an example system 400. In the system, a user 401 may place a call. The call may comprise RCD. The RCD may be inserted into the call by virtue of a user input or may be inserted by a network device (e.g., at 402). The methods and systems described herein may determine an intended recipient device is not configured to process the RCD. Based thereon, the present methods and systems may convert and/or repackage the RCD and/or generate an alternate message based thereon. The present methods and systems may cause the alternate message to be sent to the intended recipient device (e.g., at 403). The present methods and system may cause the alternate message and/or one or more notifications associated therewith to be output on the recipient device. For example, the alternate message may comprise one or more of a text message (e.g., an SMS/MMS message), an email, and/or a social media message/notification/alert, combinations thereof, and the like. The present methods and systems may cause a user device to access one or more multi-media links configured to cause output of the RCD (e.g., at 404).

FIG. 5 shows example RCD message processor logic. Example RCD is shown on the left. For example, the RCD may comprise one or more RCD claims (indicated by boxes in the figure). For example, the RCD may comprise a call reason (e.g., “internet service appointment”), a destination, a time stamp, an originator ID, logo information (e.g., at a URL), a display name, combinations thereof, and the like. The RCD message processor may reconfigure the one or more RCD claims into one or more alternate message data fields (e.g., “body,” “call back,” “media URL,” “to,” “from,” combinations thereof and the like). The RCD message processor may send the reconfigured RCD to a message device (e.g., an MMS/SMS message device). The message device may generate the alternate message. The alternate message may comprise information from the RCD claims reconfigured (e.g., repackaged) into the alternate message format. The systems described may support translation services between languages. The present methods and systems may incorporate artificial intelligence, machine learning, and/or large language models. For example, the present methods and systems may screen for profanity/obscenity, or other undesirable language or content and prevent delivery thereof and/or alert an intended recipient (or sender) thereof.

FIG. 6 shows an example system and method 600. The example system and method 600 shows a terminating network implementation of the systems and methods described herein. At step 1, a call initiation message (e.g., a communication request, an invite) may be placed. The call initiation message may be sent by an originating user device associated with an originating network. The call initiation message may comprise a call invite. The call initiation message may comprise supplemental data. For example, the call initiation message may comprise rich call data, image data, audio data, resource data, combinations thereof, and the like. The call initiation message may comprise one or more identifiers associated with the originating device (e.g., the device in the originating network) and one or more identifiers associated with the device in the terminating network. At step 2, the call initiation message may transit the transit network and be received by a switch. At step 3, the switch may forward the call comprising RCD to an authentication/verification device (e.g., a STIR/SHAKEN server). The authentication/verification server may verify and/or sign the data in the call initiation message.

The authentication/verification server may determine the presence of the RCD, decode the call (e.g., decode the identity header, decode other data in the call), and determine whether the recipient device is configured to process RCD. The authentication/verification server may be configured to decode one or more identity headers, one or more display names, SIP invite information, or other information as described herein in a call initiation message (e.g., call invite) sent from the sending user device.

At 4, based on determining the call comprises RCD, the authentication/verification server may pass the RCD to an RCD device (e.g., an RCD message processor). The RCD device may be configured to determine (e.g., by querying a database), whether a recipient user device is configured to process RCD. The RCD processor may convert the information in the RCD to an alternate message. For example, the alternate message may comprise a text message (e.g., an SMS message), an email, a social media message/notification/alert, combinations thereof, and the like. At 4A, the RCD message processor may send the alternate message data to a messaging center. At 5, the call initiation message (e.g., the invite) may be sent to the recipient user device. At 5A, the messaging center may send the alternate message to the recipient user device and cause a notification of the delivery to be output on the recipient user device. At 6, the recipient user device may send a ringing signal to the switch device. At 7, the switch device may send the ringing signal out to the transit network. At 8, the transit network may send the ringing signal to the originating user device. At 9, if the call is answered, the recipient user device may send an OK signal to the switch. At 10, the switch may send the OK signal to the transit network and at 11 the transit network may send the OK signal to the originating user device.

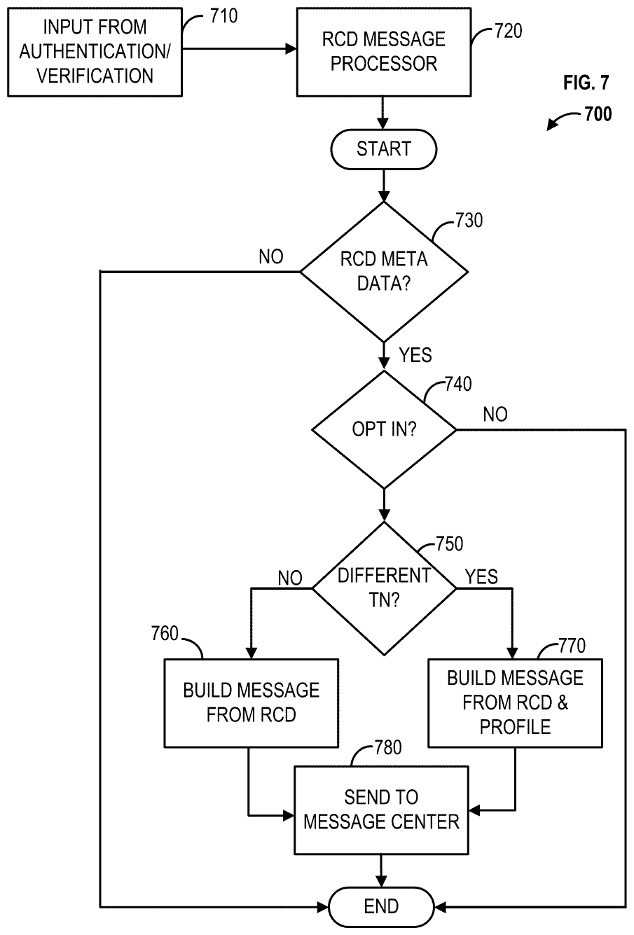

FIG. 7 shows a flowchart of a method 700. The method 700 may be carried out on any one or more of the devices described herein. The exemplary method in FIG. 7 shows RCD Processor logic for a terminating network implementation of the systems and methods described herein. For example, at 710, input from an authentication/verification device (e.g., a STIR/SHAKEN server) may be sent to an RCD device (e.g., an RCD message processor) for further processing. The input from the authentication/verification device may be sent to the RCD device based on a determination that a call initiation message comprises RCD. At 720, the RCD device may receive and process the data received from the authentication/verification device. For example, at 730, the RCD device may determine one or more RCD claims (e.g., RCD metadata). If yes, at 740, it may be determined whether a user (e.g., a recipient user device) has opted in for an alternate messaging service. The alternate messaging service may be configured to deliver, to a recipient device, despite the recipient device not being configured to process RCD, information contained in the RCD as described herein. For example, the alternate messaging service may be configured to send one or more text messages (e.g., SMS messages), emails, social media messages/notifications/alerts, combinations thereof, and the like. If yes, at 750, it may be determined whether the recipient user device is associated with a different telephone number, or is associated with one or more preferences. If no, at 760, an alternate message may be constructed based on the RCD claims. If yes, at 770, the alternate message may be constructed based on the RCD claims and based on one or more user preferences. At 780, the alternate message may be sent to the recipient device.

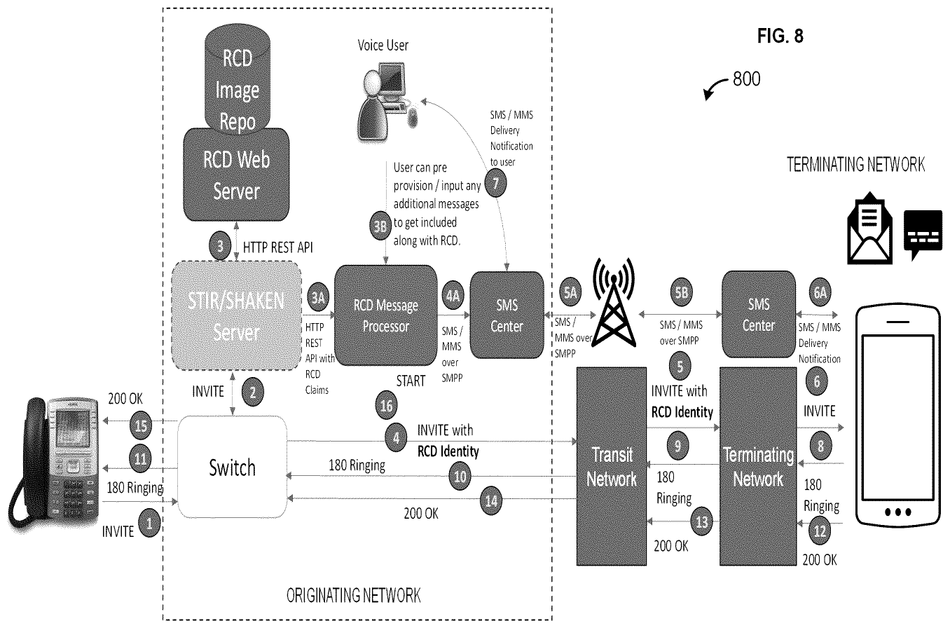

FIG. 8 shows an example system and method 800. The example system and method 800 may be carried out via any one or more devices described herein. The example system and method 800 shows an originating network implementation of the systems and methods described herein. For example, at 1, a user device associated with the originating network may send an invite (e.g., place a call). The invite may be received by a switch device. At 2, the switch device may send (e.g., forward) the invite to an authentication/verification device (e.g., a STIR/SHAKEN server). The authentication/verification device may verify and sign the call. At 3, the authentication/verification device may send the RCD information (e.g., via an HTTP REST API), to an RCD device (e.g., an RCD web server). For example, the RCD device may request the RCD information from the authentication/verification device. For example, the authentication/verification device may push the RCD information to the RCD device. The RCD device may comprise and/or otherwise be associated with an RCD image repository. At 3A, the authentication/verification device may send RCD to an RCD message processor. For example, the authentication/verification device may send the RCD via an HTTP REST API with RCD claims. Optionally, at 3B, preprovisioned input/additional messages (e.g., voice input, audio data, etc . . . ) may be received by the RCD message processor to be included in an alternate message. At 4, the switch may send the invite with RCD data out to a transit network. At 4A, the RCD message processor may send RCD to a message device (e.g., an SMS center). At 5, the transit network may send the invite with RCD identity data to a terminating network. At 5A, the message device (e.g., SMS center) may send the alternate message (e.g., an SMS message, an email, a social media message)) over SMPP or some other appropriate protocol. At 5B, the alternate message may be received by a message center associated with the terminating network. At 6, the terminating network may send the invite to the recipient user device. At 6A, the message center associated with the terminating network may send the alternate message to the recipient user device. For example, the recipient user device may receive both the original invite with RCD and the alternate message generated based on the RCD. The invite with RCD may comprise one or more URLs. The determination that the recipient user device is not configured to process RCD may be based on a determination that the recipient user device has not accessed the URL in the RCD. At 7, the message center may deliver a notification to a user who previously provisioned user input. At 8, a ringing signal may be sent by the recipient user device out to the terminating network. At 9, the ringing signal may be sent by the terminating network to the transit network. At 10, the ringing signal may be sent be the transit network to the originating network to be received by the switch device. At 11, the switch may forward the ringing signal to the originating user device. If the call is answered, at 12, the recipient user device may send an OK signal to the terminating network. At 13, the terminating network may send the OK signal to the transit network. At 14, the transit network may send the OK signal to the switch. At 15, the switch may send the OK signal to the originating user device, and the call may be connected at 16 when the switch connects the originating user device with the transit network (and ultimately to the recipient user device).

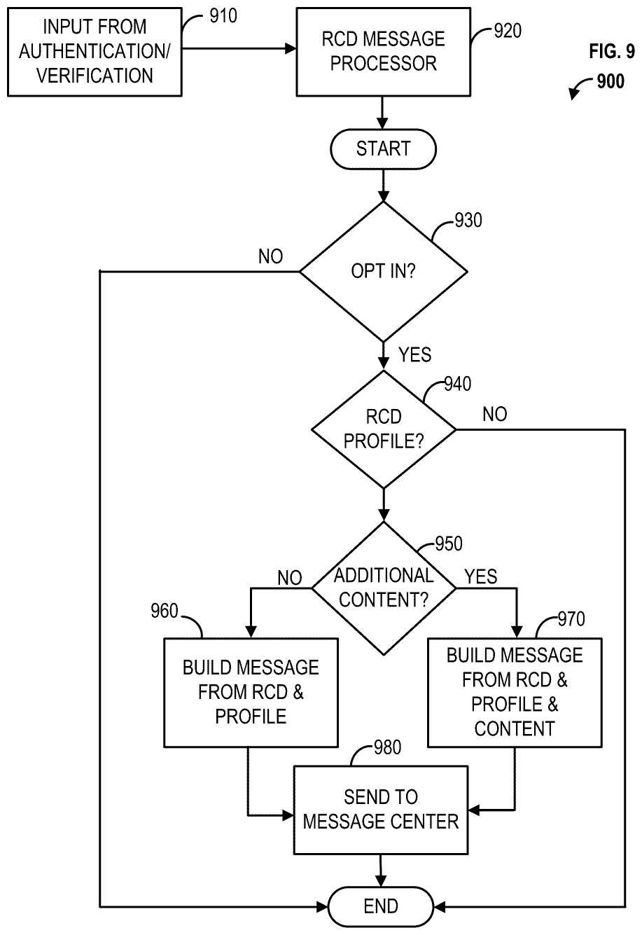

FIG. 9 shows an example method 900. The example method 900 may be carried out by any one or more devices described herein. The example method 900 shows an originating network implementation of the systems and methods described herein. At 910, input from an authentication/verification device (e.g., a STIR/SHAKEN server) may be sent for further processing. The input from the authentication/verification server may be sent for further processing based on a determination that the authentication/verification server received RCD. The RCD may be associated with a call initiation message. The authentication/verification server may be configured to sign and/or verify data in the call initiation message. For example, the authentication/verification server may be configured to verify a caller identity (e.g., an identity associated with an originating user device that placed the call initiation message). At 920, the RCD may be received by an RCD processing device (e.g., an RCD message processor). At 930, it may be determined whether or not a user has opted into an alternate messaging service. The alternate messaging service may be configured to deliver, to a recipient device, despite the recipient device not being configured to process RCD, information contained in the RCD as described herein. For example, the alternate messaging service may be configured to send one or more text messages (e.g., SMS messages), emails, social media messages/notifications/alerts, combinations thereof, and the like. If yes, at 940, it may be determined whether or not the user (e.g., a user associated with the recipient user device and/or the recipient user device itself) is associated with an RCD profile. The RCD profile may comprise information indicating one or more alternate messaging capabilities, configurations, and/or preferences. If yes, at 950, it may be determined whether the user and/or recipient user device is associated with additional content (e.g., sale offers, rewards, advertising, etc.) and/or other preferences. If no, at 960, the alternate message may be constructed using the information in the RCD. If yes, at 970 the alternate message may be constructed using the information in the RCD according to the RCD profile and/or preferences. At 980, the alternate message may be sent to the recipient user device.

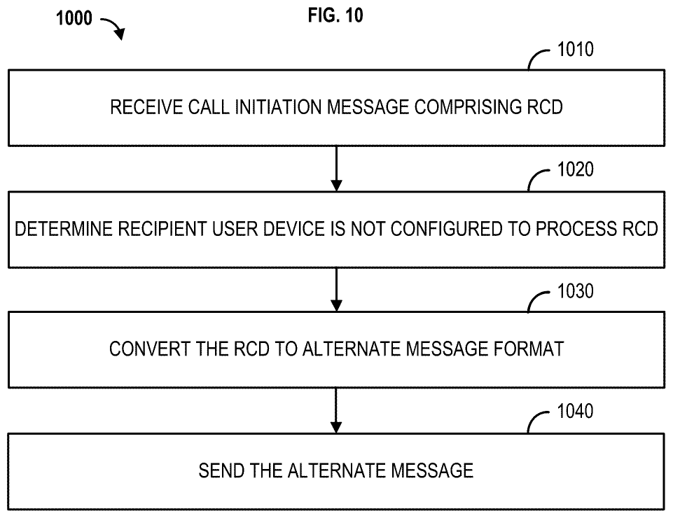

FIG. 10 shows an example method 1000. The method 1000 may be carried out via any one or more of the devices described herein. At 1010, a call initiation message may be received. The call initiation message may be received by a computing device. For example, the computing device may comprise one or more of an interceptor device, a switch device, an authentication/verification (e.g., a STIR/SHAKEN device), a rich call data (RCD) processing device, and/or a messaging device. For example, the call initiation message may comprise RCD. For example, the one or more RCD claims may comprise CNAP (Caller Name Presentation) data, CNAM (Caller Name Delivery) data, one or more CRN/call reasons, one or more logos or other image data, one or more origination or destination headers, one or more identity headers, one or more display name headers, one or more URLs, combinations thereof, and the like. The RCD may be associated with a call initiation message. The call initiation message may comprise one or more user device identifiers. For example, the call initiation message may comprise one or more user device identifiers associated with an originating device (e.g., a device that sent the call initiation message) and/or one or more user device identifiers associated with a recipient user device (e.g., the device for which the call initiation message is intended).

At 1020, it may be determined that the recipient user device is not configured to process the RCD. For example, the determination may be based on the one or more user device identifiers associated with the recipient device. For example, the computing device may query a database to determine the recipient user device is not configured to process the RCD. The method may comprise determining the recipient user device is registered for alternate messaging services (e.g., SMS, email, social media).

At 1030, the RCD may be converted to one or more messaging formats. For example, converting the RCD may comprise one or more of encoding, decoding, encrypting, decrypting, transposing, repackaging, reconfiguring, combinations thereof, and the like. For example, the computing device (e.g., the interceptor device 106) may receive the call initiation message. The computing device (e.g., via the RCD device 132) may determine the presence of RCD. The RCD device 132 may parse (e.g., extract) one or more RCD claims.

For example, the computing device (e.g., via the message device 134) may convert the RCD to one or more of short messaging service (SMS) data, email, social media messages, social media notifications, combinations thereof, and the like. For the sake of explanation, the remainder of the method may to SMS data, but it is to be understood that the where the term “SMS data” is used, the method is intended to cover email messages, social media messages, GSMA standard messages, combinations thereof, and the like.

Converting the RCD data may comprise parsing (e.g., extracting) one or more RCD claims and generating textual data based on the one or more RCD claims. The computing device that receives the call initiation message that includes Rich Call Data (RCD) may extract determine and extract one or more textual elements (e.g., RCD claims) from the RCD, such as the caller's name, phone number, and the reason for the call. For example, the RCD device 132 may send data to the message device 134. For example, if the RCD includes a caller name like “John Doe” and a call reason such as “Appointment Reminder,” the resulting SMS might read: “John Doe is calling regarding your appointment at 2:00 PM.”

The computing device or an associated device (e.g., the message device 134) may format the SMS data for delivery. For example, the computing device or the associated device may determine formatting information such as character limits and selective construct the SMS message according to the formatting information. The formatting information may be determined based on a device identifier associated with the recipient user device.

At 1040, one or more of the (SMS) data, email, social media messages, social media notifications, combinations thereof, and the like may be sent to the recipient user device.

The method may comprise causing the recipient user device to output the (SMS) data, email, social media messages, social media notifications, combinations thereof, and the like. The method may comprising storing the RCD in a database.

The method may comprise receiving, by a first computing device, rich call data (RCD) associated with a call initiation message. The method may comprise determining, based on the call initiation message, a recipient user device is not configured to process the RCD. The method may comprise determining the recipient is registered for alternate messaging services (e.g., SMS, email, social media). The method may comprise, based on determining the recipient user device is not configured to process the RCD, sending the RCD to a second computing device. The method may comprise causing the second user device to convert the RCD to short message service (SMS) data.

The method may comprise receiving, by a computing device, a call initiation message comprising rich call data (RCD). The method may comprise determining an RCD processing status associated with a recipient user device. The method may comprise, based on determining the RCD processing status associated with the recipient user device, converting the RCD to short message service (SMS) data. The method may comprise sending the SMS data and the RCD to the recipient user device.

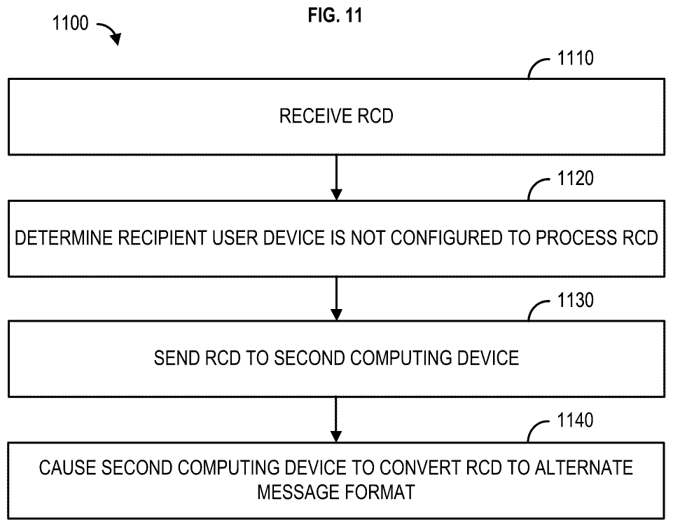

FIG. 11 shows an example method 1100. The method 1100 may be carried out on any one or more of the devices described herein. At step 1110, rich call data (RCD) may be received. For example, the RCD may comprise one or more RCD claims. For example, the one or more RCD claims may comprise CNAP (Caller Name Presentation) data, CNAM (Caller Name Delivery) data, one or more CRN/call reasons, one or more logos or other image data, one or more origination or destination headers, one or more identity headers, one or more display name headers, one or more URLs, combinations thereof, and the like. The RCD may be associated with a call initiation message. The call initiation message may comprise one or more user device identifiers. For example, the call initiation message may comprise one or more user device identifiers associated with an originating device (e.g., a device that sent the call initiation message) and/or one or more user device identifiers associated with a recipient user device (e.g., the device for which the call initiation message is intended). For example, the call initiation message may be received by a computing device. For example, the computing device may comprise one or more of an interceptor device, a switch device, an authentication/verification (e.g., a STIR/SHAKEN device), an RCD processing device, and/or a messaging device.

At 1120, it may be determined that the recipient user device is not configured to process the RCD. The method may comprise determining the recipient is registered for alternate messaging services (e.g., SMS, email, social media). For example, the determination may be based on the one or more user device identifiers associated with the recipient device. For example, the computing device may query a database to determine the recipient user device is not configured to process the RCD.

At 1130, the RCD may be sent to a second computing device. For example, the second computing device may comprise one or more of a messaging device, an authentication/verification device (e.g., a STIR/SHAKEN server), an RCD processing device, combinations thereof, and the like. The RCD may be sent to the second computing device based on the determination that the recipient user device is not configured to process the RCD.

At 1140, the second computing device may be caused to convert (e.g., decode, encode, decrypt, encrypt, repackaged, reconfigure, transpose, change fields) the RCD data. For example, the second computing device may convert the RCD to one or more of short messaging service (SMS) data, email, social media messages, social media notifications, combinations thereof, and the like. For example, the computing device (e.g., the interceptor device 106) may receive the call initiation message. The computing device (e.g., via the RCD device 132) may determine the presence of RCD. The RCD device 132 may parse (e.g., extract) one or more RCD claims.

For example, the computing device (e.g., via the message device 134) may convert the RCD to one or more of short messaging service (SMS) data, email, social media messages, social media notifications, combinations thereof, and the like. For the sake of explanation, the remainder of the method may to SMS data, but it is to be understood that the where the term “SMS data” is used, the method is intended to cover email messages, social media messages, GSMA standard messages, combinations thereof, and the like.

Converting the RCD data may comprise parsing (e.g., extracting) one or more RCD claims and generating textual data based on the one or more RCD claims. The computing device that receives the call initiation message that includes Rich Call Data (RCD) may extract determine and extract one or more textual elements (e.g., RCD claims) from the RCD, such as the caller's name, phone number, and the reason for the call. For example, the RCD device 132 may send data to the message device 134. For example, if the RCD includes a caller name like “John Doe” and a call reason such as “Appointment Reminder,” the resulting SMS might read: “John Doe is calling regarding your appointment at 2:00 PM.”

The computing device or an associated device (e.g., the message device 134) may format the SMS data for delivery. For example, the computing device or the associated device may determine formatting information such as character limits and selective construct the SMS message according to the formatting information. The formatting information may be determined based on a device identifier associated with the recipient user device.

The method may comprise causing the second computing device to send the converted RCD (e.g., send the SMS data, the email, the social media message, the social media notification) to the recipient user device.

The method may comprise receiving, by a computing device, a call initiation message comprising rich call data (RCD). The method may comprise determining a recipient user device is not configured to process the RCD. The method may comprise, based on determining the recipient user device is not configured to process the RCD, converting the RCD to short message service (SMS) data. The method may comprise sending the SMS data to the recipient user device.

The method may comprise receiving, by a computing device, a call initiation message comprising rich call data (RCD). The method may comprise determining an RCD processing status associated with a recipient user device. The method may comprise, based on determining the RCD processing status associated with the recipient user device, converting the RCD to short message service (SMS) data. The method may comprise sending the SMS data and the RCD to the recipient user device.

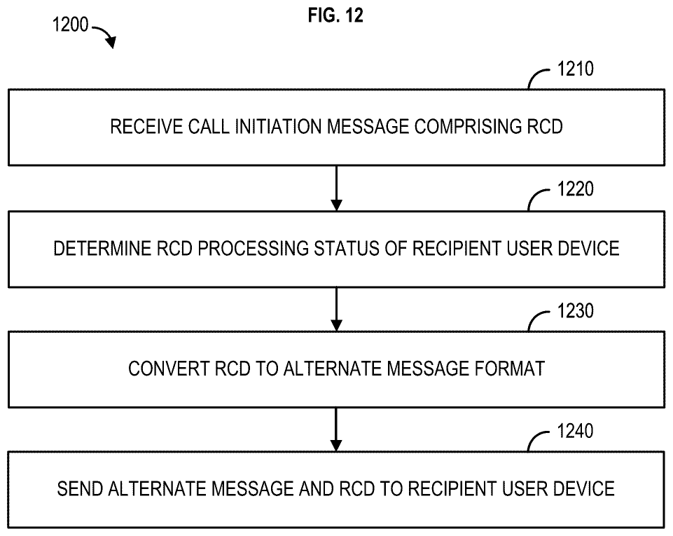

FIG. 12 shows an example method 1200. The method 1200 may be carried out via any one or more of the devices described herein. At 1210, a call initiation message may be received. For example, the call initiation message may be received by a computing device. For example, the computing device may comprise one or more of an interceptor device, a switch device, an authentication/verification device (e.g., a STIR/SHAKEN device), an RCD processing device, and/or a messaging device. The call initiation message may comprise one or more user device identifiers. For example, the call initiation message may comprise one or more user device identifiers associated with an originating device (e.g., a device that sent the call initiation message) and/or one or more user device identifiers associated with a recipient user device (e.g., the device for which the call initiation message is intended). For example, the call initiation message may comprise rich call data (RCD). For example, the RCD may comprise one or more RCD claims. For example, the one or more RCD claims may comprise CNAP (Caller Name Presentation) data, CNAM (Caller Name Delivery) data, one or more CRN/call reasons, one or more logos or other image data, one or more origination or destination headers, one or more identity headers, one or more display name headers, one or more URLs, combinations thereof, and the like.

At 1220, an RCD processing status associated with the recipient user device may be determined. For example, the RCD processing status may be determined based on the one or more user device identifiers associated with the recipient device. For example, the computing device may query a database to determine the RCD processing status associated with the recipient user device. For example, the RCD processing status may indicate one or more RCD processing capabilities associated with the recipient user device. For example, the RCD processing status may indicate the recipient user device is not configured to process the RCD. For example, the RCD processing status may indicate the recipient user device is configured to process the RCD. Determining the RCD processing status is optional and the remainder of the method may be performed regardless of determining the RCD processing status.

At 1230, the RCD may be converted (e.g., repackaged, transposed, decoded, encoded, decrypted, or encrypted). For example, the RCD may be converted to one or more messaging protocols (e.g., one or more alternate messaging protocols). For example, the RCD may be converted to short messaging service (SMS) data, email, instant messaging, social media messaging or notifications, combinations thereof, and the like. For the sake of explanation, the remainder of the method refers to SMS data, but it is to be understood that the where the term “SMS data” is used, the method is intended to cover email messages, social media messages, GSMA standard messages, combinations thereof, and the like. For example, the computing device (e.g., the interceptor device 106) may receive the call initiation message. The computing device (e.g., via the RCD device 132) may determine the presence of RCD. The RCD device 132 may parse (e.g., extract) one or more RCD claims.

For example, the computing device (e.g., via the message device 134) may convert the RCD to one or more of short messaging service (SMS) data, email, social media messages, social media notifications, combinations thereof, and the like. For the sake of explanation, the remainder of the method may to SMS data, but it is to be understood that the where the term “SMS data” is used, the method is intended to cover email messages, social media messages, GSMA standard messages, combinations thereof, and the like.

Converting the RCD data may comprise parsing (e.g., extracting) one or more RCD claims and generating textual data based on the one or more RCD claims. The computing device that receives the call initiation message that includes Rich Call Data (RCD) may extract determine and extract one or more textual elements (e.g., RCD claims) from the RCD, such as the caller's name, phone number, and the reason for the call. For example, the RCD device 132 may send data to the message device 134. For example, if the RCD includes a caller name like “John Doe” and a call reason such as “Appointment Reminder,” the resulting SMS might read: “John Doe is calling regarding your appointment at 2:00 PM.”

The computing device or an associated device (e.g., the message device 134) may format the SMS data for delivery. For example, the computing device or the associated device may determine formatting information such as character limits and selective construct the SMS message according to the formatting information. The formatting information may be determined based on a device identifier associated with the recipient user device.

At 1240, the SMS data and the RCD may be sent to the recipient user device. The SMS data and the RCD may be sent simultaneously. For example, the SMS data and the RCD may be sent by the computing device. For example, the computing device may cause a second computing device to send the SMS data and RCD to the recipient user device.

The method may comprise determining one or more display capabilities associated with the recipient user device. The method may comprise determining one or more audio output capabilities associated with the recipient user device. The method may comprise saving the RCD in a database. The method may comprise causing the recipient device to output one or more of the SMS data, the email, or the social media messaging or notification.

The method may comprise receiving, by a computing device, a call initiation message comprising rich call data (RCD). The method may comprise determining a recipient user device is not configured to process the RCD. The method may comprise determining the recipient is registered for alternate messaging services (e.g., SMS, email, social media). The method may comprise, based on determining the recipient user device is not configured to process the RCD, converting the RCD to short message service (SMS) data. The method may comprise sending the SMS data to the recipient user device.

The method may comprise receiving, by a first computing device, rich call data (RCD) associated with a call initiation message. The method may comprise determining, based on the call initiation message, a recipient user device is not configured to process the RCD. The method may comprise, based on determining the recipient user device is not configured to process the RCD, sending the RCD to a second computing device. The method may comprise causing the second user device to convert the RCD to short message service (SMS) data.

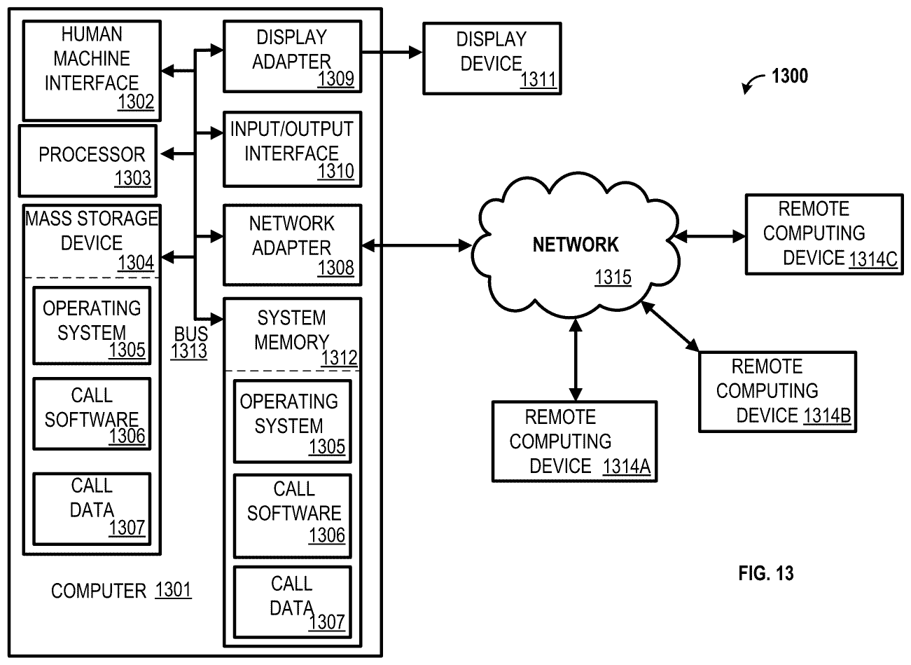

FIG. 13 shows a system 1300 for communication management. The media device 120, the output device 121, the communication terminal 122, the mobile device 124, the content source 102, the encoder 104, the one or more wagering services 108, and/or the network component 129 of FIG. 1 may be a computer 1301 as shown in FIG. 13. The computer 1301 may comprise one or more processors 1303, a system memory 1312, and a bus 1313 that couples various system components including the one or more processors 1303 to the system memory 1312. In the case of multiple processors 1303, the computer 1301 may utilize parallel computing. The bus 1313 is one or more of several possible types of bus structures, including a memory bus or memory controller, a peripheral bus, an accelerated graphics port, or local bus using any of a variety of bus architectures.

The computer 1301 may operate on and/or comprise a variety of computer readable media (e.g., non-transitory). The readable media may be any available media that is accessible by the computer 1301 and may comprise both volatile and non-volatile media, removable and non-removable media. The system memory 1312 has computer readable media in the form of volatile memory, such as random access memory (RAM), and/or non-volatile memory, such as read only memory (ROM). The system memory 1312 may store data such as the call data 1307 and/or program modules such as the operating system 1305 and the call software 1306 that are accessible to and/or are operated on by the one or more processors 1303. The machine learning module may comprise one or more of the call data 1307 and/or the call software 1306.

The computer 1301 may also comprise other removable/non-removable, volatile/non-volatile computer storage media. FIG. 13 shows the mass storage device 1304 which may facilitate non-volatile storage of computer code, computer readable instructions, data structures, program modules, and other data for the computer 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1304, such as the operating system 1305 and the call software 1306. Each of the operating system 1305 and the call software 1306 (or some combination thereof) may comprise elements of the program modules and the call software 1306. The call data 1307 may also be stored on the mass storage device 1304. The call data 1307 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1315.

A user may enter commands and information into the computer 1301 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1303 via a human machine interface 1302 that is coupled to the bus 1313, but may be connected by other interface and bus structures, such as a parallel port, game port, an IEEE 1394 Port (also known as a Firewire port), a serial port, network adapter 1308, and/or a universal serial bus (USB).

The display device 1311 may also be connected to the bus 1313 via an interface, such as the display adapter 1309. It is contemplated that the computer 1301 may comprise more than one display adapter 1309 and the computer 1301 may comprise more than one display device 1311. The display device 1311 may be a monitor, an LCD (Liquid Crystal Display), light emitting diode (LED) display, television, smart lens, smart glass, and/or a projector. In addition to the display device 1311, other output peripheral devices may be components such as speakers (not shown) and a printer (not shown) which may be connected to the computer 1301 via the Input/Output Interface 1310. Any step and/or result of the methods may be output (or caused to be output) in any form to an output device. Such output may be any form of visual representation, including, but not limited to, textual, graphical, animation, audio, tactile, and the like. The display device 1311 and computer 1301 may be part of one device, or separate devices.

The computer 1301 may operate in a networked environment using logical connections to one or more remote computing devices 1314A,B,C B, C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1301 and a remote computing device 1314A, B, C may be made via 1315 network 1315, such as a local area network (LAN) and/or a general wide area network (WAN). Such network connections may be through the network adapter 1308. The network adapter 1308 may be implemented in both wired and wireless environments. Such networking environments are conventional and commonplace in dwellings, offices, enterprise-wide computer networks, intranets, and the Internet.

Application programs and other executable program components such as the operating system 1305 are shown herein as discrete blocks, although it is recognized that such programs and components reside at various times in different storage components of the computing device 1301, and are executed by the one or more processors 1303 of the computer. An implementation of the call software 1306 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, a call initiation message comprising rich call data (RCD);
determining that a recipient device is not configured to process the RCD;
based on determining the recipient user device is not configured to process the RCD, converting the RCD to short message service (SMS) data; and
sending the SMS data to the recipient user device.

2. The method of claim 1, wherein the first computing device comprises one or more of a switch device or an RCD processor device.

3. The method of claim 1, wherein the call initiation message comprises one or more user device identifiers associated with an originating user device and one or more user device identifiers associated with the recipient user device.

4. The method of claim 1, wherein determining the recipient user device is not configured to process the RCD is based on one or more user device identifiers associated with the recipient user device.

5. The method of claim 1, wherein converting the RCD to SMS data comprises determining one or more claims in the RCD and converting the one or more claims to the SMS data.

6. The method of claim 1, wherein converting the RCD to SMS comprises extracting one or more of: one or more RCD claims, one or more RCD logos, or multimedia from the call initiation message.

7. The method of claim 1, wherein converting the RCD to SMS data comprises formatting one or more RCD claims into a structured SMS message.

8. The method of claim 1, further comprising causing the recipient user device to output the SMS data.

9. The method of claim 1, further comprising sending the RCD data to a database.

10. A method comprising:
receiving, by a first computing device, rich call data (RCD) associated with a call initiation message;
determining, based on the call initiation message, a recipient user device is not configured to process the RCD;
based on determining the recipient user device is not configured to process the RCD, sending the RCD to a second computing device; and
causing the second computing device to convert the RCD to short message service (SMS) data.

11. The method of claim 10, wherein the first computing device comprises an RCD processor device.

12. The method of claim 10, wherein the call initiation message comprises one or more user device identifiers associated with an originating user device and one or more user device identifiers associated with the recipient user device.

13. The method of claim 10, wherein receiving the SMS data is based on a determination that the recipient user device is not configured to process the RCD.

14. The method of claim 10, wherein causing the second computing device to convert the RCD to SMS data comprises causing the second computing device to extract one or more of: one or more RCD claims, one or more RCD logos, or multimedia from the call initiation message.

15. The method of claim 10, wherein causing the second computing device to convert the RCD to SMS data comprises causing the second computing device to format one or more RCD claims into a structured SMS message.

16. The method of claim 10, further comprising causing the second computing device to send, to the recipient user device one or more of: the SMS data, an email, or a social media message, wherein the one or more of the SMS data, the email, or the social media message comprise repackaged RCD.

17. The method of claim 10, further comprising storing, on a device associated with a terminating network associated with the recipient user device, the RCD.

18. The method of claim 10, further comprising causing the recipient user device to output the SMS data.

19. A method comprising:
receiving, by a computing device, a call initiation message comprising rich call data (RCD);
determining an RCD processing status associated with a recipient user device;
based on determining the RCD processing status associated with the recipient user device, converting the RCD to short message service (SMS) data; and
sending the SMS data and the RCD to the recipient user device.

20. The method of claim 19, wherein the computing device comprises one or more of a switch device or an RCD processor device.

21. The method of claim 19, wherein the call initiation message comprises one or more user device identifiers associated with an originating user device and one or more user device identifiers associated with the recipient user device.

22. The method of claim 19, wherein converting the RCD to SMS comprises extracting one or more of: one or more RCD claims, one or more RCD logos, or multimedia from the call initiation message.

23. The method of claim 19, wherein converting the RCD to SMS comprises formatting one or more RCD claims into a structured SMS message.

24. The method of claim 19, further comprising sending, to the recipient user device, based on the RCD one or more of: an email or a social media message.

25. The method of claim 19, further comprising saving the RCD data.

26. The method of claim 19, further comprising causing the recipient user device to output the SMS data.
